(19) United States
(12) Patent Application Publication
(10) Pub. No.: US 2026/0086599 A1
(43) Pub. Date: Mar. 26, 2026

(54) DATA COMMUNICATION SYSTEM FOR CONTROLLING THEREOF

(71) Applicant: SAMSUNG ELECTRONICS CO., LTD., Suwon-si (KR)

(72) Inventors: Changwan KIM, Suwon-si (KR); Minku KOO, Suwon-si (KR); Mira KIM, Suwon-si (KR); Judai KIM, Suwon-si (KR); Dongin JANG, Suwon-si (KR); Minjoon JUNG, Suwon-si (KR); Changjoo CHAI, Suwon-si (KR)

(73) Assignee: SAMSUNG ELECTRONICS CO., LTD., Suwon-si (KR)

(21) Appl. No.: 19/388,370

(22) Filed: Nov. 13, 2025

Related U.S. Application Data
(63) Continuation of application No. PCT/KR2025/013638, filed on Sep. 4, 2025.

(30) Foreign Application Priority Data
Sep. 23, 2024 (KR) 10-2024-0128573

(51) Int. Cl. G06F 1/10

(52) U.S. Cl. CPC G06F 1/10

(57) ABSTRACT

A data communication system includes a slave device; and a master device configured to perform data communication with the slave device through a clock line that transmits a clock signal and a data line that transmits a data signal. The master device stores a bit value corresponding to the data signal received through the data line for each clock of the clock signal in a first buffer, stores a plurality of monitoring values in a second buffer by sampling the received data signal for each clock, and corrects the bit value stored in the first buffer based on the plurality of monitoring values stored in the second buffer for each clock.

### CROSS-REFERENCE TO RELATED APPLICATION

This application is a continuation application, under 35 U.S.C. § 111(a), of international application No. PCT/KR2025/013638, filed Sep. 4, 2025, which claims priority under 35 U.S.C. § 119 to Korean Patent Application No. 10-2024-0128573, filed Sep. 23, 2024, the disclosures of which are incorporated herein by reference in their entireties.

### TECHNICAL FIELD

The disclosed invention relates to a data communication system and a method for controlling thereof using an I2C communication method.

### BACKGROUND ART

Various electronic devices such as home appliances include various electronic components. I2C (Inter-Integrated Circuit) communication is used to transmit or receive data between various electronic components. For example, I2C communication can be used in electronic components such as processors, memories, input devices, output devices, and sensors. I2C communication enables data transmission between a master device and a slave device using two signal lines. The master device and slave device can perform bidirectional synchronized communication through a clock line (SCL) and a data line (SDA).

However, data signals transmitted through the data line of I2C communication can be distorted due to the influence of noise. When various electronic components (e.g., AC loads, relays, etc.) included in home appliances operate, noise that affects I2C communication can occur. Distortion of data signals can cause data corruption or errors.

### DISCLOSURE

### Technical Solution

The disclosed invention provides a data communication system and a method for controlling therefore capable of correcting data errors caused by noise in I2C (Inter-Integrated Circuit) communication.

According to an embodiment of the disclosure, a data communication system may include a slave device and a master device configured to perform data communication with the slave device through a clock line that transmits a clock signal and a data line that transmits a data signal. The master device may store a bit value corresponding to the data signal which is received through the data line for each clock of the clock signal in a first buffer. The master device may store a plurality of monitoring values in a second buffer by sampling the received data signal for each clock. The master device may correct the bit value stored in the first buffer using the plurality of monitoring values stored in the second buffer for each clock.

According to an embodiment of the disclosure, a method for controlling a data communication system, the method may include storing, by a master device configured to perform data communication with a slave device through a data line and a clock line, a bit value corresponding to a data signal received through the data line in a first buffer for each clock of a clock signal transmitted through the clock line; storing, by the master device, a plurality of monitoring values in a second buffer based on sampling the received data signal for each clock; and correcting, by the master device, the bit value stored in the first buffer based on the plurality of monitoring values stored in the second buffer for each clock.

According to the disclosure, a data communication system and a method for controlling therefore may correct data errors caused by noise in I2C (Inter-Integrated Circuit) communication.

According to the disclosure, a data communication system and a method for controlling therefore may ensure the stability of I2C communication even in environments with high noise levels.

### DESCRIPTION OF DRAWINGS

FIG. 1 is a diagram of a network system implemented by various electronic devices according to an embodiment.

FIG. 2 illustrates a data communication system according to an embodiment.

FIG. 3 illustrates a block diagram illustrating the configuration of a master device and a slave device of a data communication system according to an embodiment.

FIG. 4 illustrates a clock signal and a data signal for transmitting data between a master device and a slave device of a data communication system according to an embodiment.

FIGS. 5 and 6 illustrate cases where data errors may occur due to noise according to an embodiment.

FIG. 7 is a diagram for explaining sampling of a data signal performed by a data communication system according to an embodiment.

FIG. 8 shows an example of data correction performed by a data communication system according to an embodiment.

FIG. 9 shows an example of data correction performed by a data communication system according to an embodiment.

FIG. 10 shows an example of data correction performed by a data communication system according to an embodiment.

FIG. 11 shows a case where data correction is not performed in a data communication system according to an embodiment.

FIG. 12 is a flowchart briefly showing a method for controlling a data communication system according to an embodiment.

FIG. 13 is a flowchart detailing a method for correcting bit values stored in a first buffer described in FIG. 12 according to an embodiment.

FIG. 14 shows an embodiment that modifies the method for controlling the data communication system described in FIG. 12 according to an embodiment.

### MODES OF THE DISCLOSURE

Various embodiments of the disclosure and terms used herein are not intended to limit the technical features described herein to specific embodiments, and should be understood to include various modifications, equivalents, or substitutions of the corresponding embodiments. In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

As used herein, the term “and/or” includes any and all combinations of one or more of the associated listed items.

Hereinafter, the principles of operation and embodiments of the disclosure will be described with reference to the accompanying drawings.

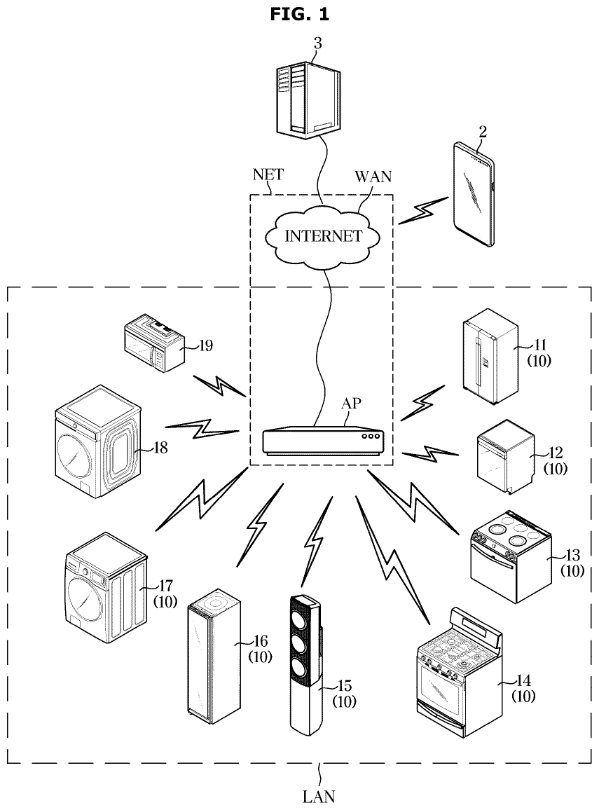

FIG. 1 is a diagram of a network system implemented by various electronic devices.

Referring to FIG. 1, a home appliance 10 may include a communication module capable of communicating with another home appliance, a user device 2, or a server 3, a user interface that receives a user input or outputs information to a user, at least one processor that controls an operation of the home appliance 10, and at least one memory that stores a program for controlling the operation of the home appliance 10.

The home appliance 10 may be at least one of various types of home appliances. For example, as shown in the accompanying drawings, the home appliance 10 may include a refrigerator 11, a dishwasher 12, an electric range 13, an electric oven 14, an air conditioner 15, a clothes treating apparatus 16, a washing machine 17, a dryer 18, and a microwave oven 19.

However, the home appliance 10 is not limited to those illustrated in FIG. 1. For example, the home appliance 10 may include various types of appliances not shown in the drawings, such as a cleaning robot, a vacuum cleaner, a television, and the like. Furthermore, the aforementioned home appliances are by way of example only, and in addition to the aforementioned home appliances, other appliances connected to other home appliance, the user device 2, or the server 3 to perform operations described below may be included in the home appliance 10 according to an embodiment.

The server 3 may include a communication module communicating with another server, the home appliance 10, or the user device 2, at least one processor that processes data received from another server, the home appliance 10, or the user device 2, and at least one memory that stores programs for processing data or processed data. The server 3 may be implemented as a variety of computing devices, such as a workstation, a cloud, a data drive, a data station, and the like. The server 3 may be implemented as one or more server physically or logically separated based on a function, detailed configuration of function, or data, and may transmit and receive data through communication between servers and process the transmitted and received data.

The server 3 may perform functions, such as managing a user account, registering the home appliance 10 in association with the user account, managing or controlling the registered home appliance 10, and the like. For example, a user may access the server 3 via the user device 2 and may create a user account. The user account may be identified by an identifier (ID) and a password set by the user. The server 3 may register the home appliance 10 with the user account according to a predetermined procedure. For example, the server 3 may link identification information of the home appliance 10 (e.g., a serial number or MAC address) to the user account to register, manage, and control the home appliance 10. The user device 2 may include a communication module capable of communicating with the home appliance 10 or the server 3, a user interface that receives a user input or outputs information to a user, at least one processor that controls an operation of the user device 2, and at least one memory that stores a program for controlling the operation of the user device 2.

The user device 2 may be carried by a user, or placed in a user's home or office, or the like. The user device 2 may include a personal computer (PC), a terminal, a portable telephone, a smartphone, a handheld device, a wearable device, and the like, but is not limited thereto.

The memory of the user device 2 may store a program for controlling the home appliance 10, i.e. An application. The application may be sold installed on the user device 2, or may be downloaded from an external server for installation. By running the application installed on the user device 2 by a user, the user may access the server 3, create a user account, and communicate with the server 3 based on the login user account to register the home appliance 10.

For example, by operating the home appliance 10 to allow the home appliance 10 to access the server 3 according to a procedure guided by the application installed on the user device 2, the server 3 may register the home appliance 10 with the user account by assigning the identification information (e.g., a serial number or a MAC address) of the home appliance 10 to the corresponding user account.

A user may control the home appliance 10 using the application installed on the user device 2. For example, by logging into a user account with the application installed on the user device 2, the home appliance 10 registered in the user account appears, and by inputting a control command for the home appliance 10, the control command may be delivered to the home appliance 10 via the server 3.

A network may include both a wired network and a wireless network. The wired network may include a cable network or a telephone network, and the wireless network may include any networks transmitting and receiving a signal via radio waves. The wired network and the wireless network may be interconnected.

The network may include a wide area network (WAN), such as the Internet, a local area network (LAN) formed around an access point (AP), and a short-range wireless network that does not use an AP. The short-range wireless network may include BluetoothTM (IEEE 802.15.1), Zigbee (IEEE 802.15.4), Wi-Fi Direct, near field communication (NFC), and Z-Wave, but is not limited thereto.

The AP may connect the home appliance 10 or the user device 2 to a WAN connected to the server 3. The home appliance 10 or the user device 2 may be connected to the server 3 via a WAN. The AP may communicate with the home appliance 10 or the user device 2 using wireless communication, such as Wi-FiTM (IEEE 802.11), BluetoothTM (IEEE 802.15.1), Zigbee (IEEE 802.15.4), and the like, and access a WAN using wired communication, but is not limited thereto. According to various embodiments, the home appliance 10 may be directly connected to the user device 2 or the server 3 without going through an AP.

The home appliance 10 may be connected to the user device 2 or the server 3 via a long-range wireless network or a short-range wireless network. For example, the home appliance 10 may be connected to the user device 2 via a short-range wireless network (e.g., Wi-Fi Direct). In another example, the home appliance 10 may be connected to the user device 2 or the server 3 via a WAN using a long-range wireless network (e.g., a cellular communication module). In still another example, the home appliance 10 may access a WAN using wired communication, and may be connected to another home appliance 10 or the server 3 via a WAN.

When accessing a WAN using wired communication, the home appliance 10 may also act as an AP. Accordingly, the home appliance 10 may connect another home appliance 10 to a WAN to which the server 3 is connected. In addition, another home appliance 10 may connect the home appliance 10 to the WAN to which the server 3 is connected.

The home appliance 10 may transmit information about an operation or state to other home appliances, the user device 2, or the server 3 via the network. For example, the home appliance 10 may transmit information about an operation or state to other home appliances, the user device 2 or the server 3 upon receiving a request from the server 3, in response to an event in the home appliance 10, or periodically or in real time. Upon receiving the information about the operation or state from the home appliance 10, the server 3 may update the stored information about the operation or state of the home appliance 10 and transmit the updated information about the operation and state of the home appliance 10 to the user device 2 via the network. Here, updating the information may include various operations in which existing information is changed, such as adding new information to the existing information, replacing the existing information with new information, and the like.

The home appliance 10 may obtain various information from other home appliances, the user device 2, or the server 3, and may provide the obtained information to a user. For example, the home appliance 10 may obtain information related to a function of the home appliance 10 (e.g., recipes, washing instructions, etc.) from the server 3 and various environmental information (e.g., weather, temperature, humidity, etc.), and may output the obtained information via a user interface.

The home appliance 10 may operate in accordance with a control command received from other home appliances, the user device 2, or the server 3. For example, the home appliance 10 may operate in accordance with a control command received from the server 3, based on a prior authorization obtained from a user to operate in accordance with the control command of the server 3 even without a user input. Here, the control command received from the server 3 may include a control command input by the user via the user device 2 or a control command based on preset conditions, but is not limited thereto.

The user device 2 may transmit information about a user to the home appliance 10 or the server 3 via the communication module. For example, the user device 2 may transmit information about a user's location, a user's health condition (i.e., state), a user's preference, a user's schedule, and the like to the server 3. The user device 2 may transmit information about the user to the server 3 based on the user's prior authorization.

The home appliance 10, the user device 2, or the server 3 may use techniques, such as artificial intelligence (AI) to determine a control command. For example, the server 3 may receive information about an operation or a state of the home appliance 10 or information about a user of the user device 2, process the received information using techniques, such as AI, and transmit a processing result or a control command to the home appliance 10 or the user device 2 based on the processing result.

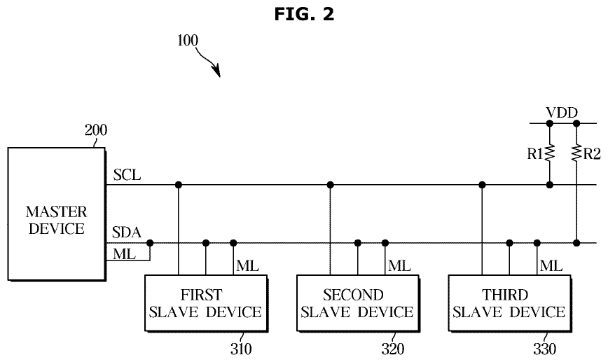

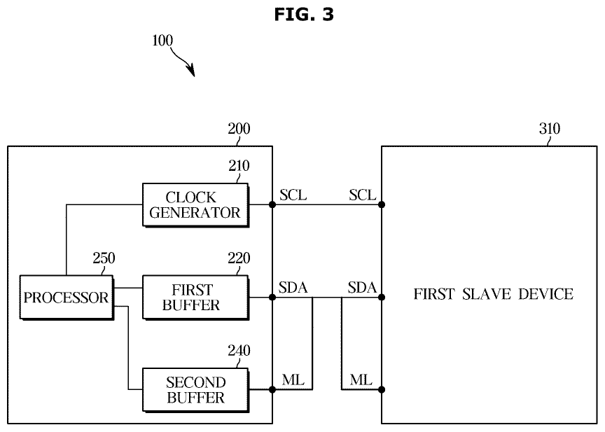

FIG. 2 illustrates a data communication system according to an embodiment. FIG. 3 illustrates a block diagram illustrating the configuration of a master device and a slave device of a data communication system according to an embodiment.

The home appliance 10 described in FIG. 1 may include a data communication system 100 that uses an I2C (Inter-Integrated Circuit) communication method. Referring to FIG. 2, the data communication system 100 may include a master device 200 and one or more slave devices 310, 320, 330. The master device 200 may be connected to one or more slave devices 310, 320, 330. Although three slave devices 310, 320, 330 are illustrated in FIG. 2, the number of slave devices is not limited to what is illustrated.

Each of the first slave device 310, the second slave device 320, and the third slave device 330 may be connected to the master device 200 by a clock line SCL and a data line SDA. A first resistor R1 may be connected between the clock line SCL and a power supply VDD. A second resistor R2 may be connected between the data line SDA and the power supply VDD. The first resistor R1 and the second resistor R2 correspond to pull-up resistors. Voltage may be supplied to each of the clock line SCL and the data line SDA through the first resistor R1 and the second resistor R2.

The master device 200 may generate a clock signal and transmit the clock signal to one or more slave devices 310, 320, 330 through the clock line SCL. The master device 200 may transmit a data signal or receive a data signal through the data line SDA in accordance with the clock signal.

Each of the plurality of slave devices 310, 320, 330 may have an individual address. The master device 200 may transmit an address value of a target slave device 310, 320, 330 to the plurality of slave devices 310, 320, 330 in order to write data to the slave devices 310, 320, 330 or read data from the slave devices 310, 320, 330. Among the plurality of slave devices 310, 320, 330, a slave device having the address value transmitted by the master device 200 may receive data or transmit data.

Additionally, the data communication system 100 may include a plurality of branch data lines ML that branch from the data line SDA and are connected to each of the master device 200 and one or more slave devices 310, 320, 330. The master device 200 may include a clock port connected to the clock line SCL, a data port connected to the data line SDA, and a monitoring port connected to the branch data line ML. Each of the first slave device 310, the second slave device 320, and the third slave device 330 may also include a clock port, a data port, and a monitoring port.

Although the branch data line ML is illustrated as branching from the data line SDA, it is not limited thereto. A plurality of branch data lines ML that directly connect the monitoring port of the master device 200 and the monitoring port of each of the slave devices 310, 320, 330 may be provided. For example, the branch data line ML may be provided to directly connect the monitoring port of the master device 200 and the monitoring port of the first slave device 310.

Referring to FIG. 3, the master device 200 may include a clock generator 210, a first buffer 220, a second buffer 240, and a processor 250. The processor 250 may be electrically connected to the clock generator 210, the first buffer 220, and the second buffer 240. The processor 250 may control each of the clock generator 210, the first buffer 220, and the second buffer 240.

The first slave device 310 may include the same configuration as the master device 200 or may include a different configuration. For example, the first slave device 310 may include a first buffer 220, a second buffer 240, and a processor 250, excluding the clock generator 210. When the first slave device 310 also includes the clock generator 210, the first slave device 310 may perform the role of a master device.

Although the first slave device 310 is used as an example for convenience of explanation, each of the plurality of slave devices 310, 320, 330 may include the same configuration as the master device 200 or may include a different configuration.

The first buffer 220 and the second buffer 240 may include volatile memory (e.g., S-RAM, D-RAM) and/or non-volatile memory (e.g., ROM, EPROM). The processor 250 and the first buffer 220 and second buffer 240 may be implemented as separate chips or may be implemented as a single chip. Additionally, a plurality of processors and a plurality of memories may be provided. The processor 250 may include one core or may include a plurality of cores.

The processor 250 may be configured to perform various operations of the master device 200. The processor 250 may include various types of circuits. For example, the processor 250 may include one or more of a CPU (Central Processing Unit), GPU (Graphics Processing Unit), APU (Accelerated Processing Unit), MIC (Many Integrated Core), DSP (Digital Signal Processor), NPU (Neural Processing Unit), hardware accelerator, or machine learning accelerator.

The clock generator 210 may generate a clock signal. The processor 250 may control the clock generator 210 to generate the clock signal. The clock signal generated by the clock generator 210 may be transmitted to the first slave device 310 through the clock line SCL. The clock signal may appear as high or low. The clock signal may be maintained high for a pulse interval and then transition to low. During one clock period, the clock signal may transition from high to low. A time interval during which the clock signal appears high may be defined as one clock, and the clock signal may include a plurality of clocks. The clock signal corresponds to a pulse signal. One clock may have a rising edge and a falling edge.

The first buffer 220 may store data. The first buffer 220 may be connected to the data line SDA. Data stored in the first buffer 220 may be transmitted to the first slave device 310 through the data line SDA. Data transmitted from the first slave device 310 may also be stored in the first buffer 220. The first buffer 220 may store a plurality of bit values corresponding to data. For example, the data signal may be a voltage signal. For each clock of the clock signal, a bit value of 1 or 0 may be stored in the first buffer 220 depending on whether the voltage level of the data signal is high (e.g., 5V) or low (e.g., 0V). The processor 250 may store a bit value corresponding to the data signal received through the data line SDA for each clock of the clock signal in the first buffer 220.

The second buffer 240 may store sampling values of the data signal. The second buffer 240 may be connected to the branch data line ML that branches from the data line SDA. The master device 200 may receive the data signal from the first slave device 310 through the data line SDA and the branch data line ML. The processor 250 may convert the data signal into a digital value of a predetermined number of bits (e.g., 10 bits). The processor 250 may sample the data signal at sampling time intervals and store a plurality of sampling values in the second buffer 240.

Although the first buffer 220 is illustrated as being connected to the data line SDA and the second buffer 240 is illustrated as being connected to the branch data line ML, it is not limited thereto. For example, the first buffer 220 and the second buffer 240 may be integrated and both connected to the data line SDA. When both the first buffer 220 and the second buffer 240 are directly connected to the data line SDA, the monitoring port of the master device 200, the monitoring port of the first slave device 310, and the branch data line ML may be removed. As another example, the data line SDA, the first buffer 220, and the second buffer 240 may be connected in series. The processor 250 may store a bit value corresponding to the data signal received through the data line SDA in the first buffer 220 and store sampling values of the data signal in the second buffer 240.

The processor 250 may perform sampling of the data signal for each clock of the clock signal to obtain a plurality of sampling values. The processor 250 may convert the data signal into a plurality of sampling values for each clock of the clock signal. The processor 250 may convert the data signal sampled at each sampling time interval into a digital value of a predetermined number of bits (e.g., 10 bits) and store the converted digital value as a sampling value.

Converting the data signal into a digital value of a predetermined number of bits may represent quantizing the data signal. Therefore, the sampling value may also be referred to as a ‘quantization value’. For example, the voltage level of the data signal may vary within a range from 0V to 5V. When the voltage level of the data signal sampled at each sampling time interval is converted into a 10-bit digital value, a sampling value within a range from 0 to 1024 corresponding to the voltage level of the sampled data signal may be stored in the second buffer 240.

Additionally, the processor 250 may correct the bit value stored in the first buffer 220 using the plurality of sampling values stored in the second buffer 240 for each clock of the clock signal. The processor 250 may determine sampling values acquired within a predetermined time range based on the falling edge of the clock among the plurality of sampling values stored in the second buffer 240 as a plurality of monitoring values. The processor 250 may determine sampling values acquired within a data setup time before the falling edge of the clock and a data valid time after the falling edge of the clock as the plurality of monitoring values.

The processor 250 may compare each of the plurality of monitoring values with a reference value to determine each of the plurality of monitoring values as a result value corresponding to a high value, a low value, or noise. For example, the processor 250 may determine each of the plurality of monitoring values as a high value based on each of the plurality of monitoring values being greater than or equal to a first reference value. The processor 250 may determine each of the plurality of monitoring values as a low value based on each of the plurality of monitoring values being less than or equal to a second reference value. The processor 250 may determine each of the plurality of monitoring values as noise based on each of the plurality of monitoring values being less than the first reference value and greater than the second reference value. The first reference value may be set to be greater than the second reference value.

The processor 250 may correct the bit value stored in the first buffer 220 using the plurality of result values. For example, the processor 250 may correct the bit value stored in the first buffer 220 to a high value or a low value based on a first ratio of high values or a second ratio of low values among the plurality of monitoring values being greater than or equal to a threshold value. When the first ratio of high values or the second ratio of low values among the plurality of monitoring values is less than the threshold value, the processor 250 may not correct the bit value stored in the first buffer 220.

The processor 250 may determine a first ratio of high values and a second ratio of low values among the plurality of monitoring values. The processor 250 may determine a ratio of the number of high values to the number of the plurality of monitoring values as the first ratio of high values. The processor 250 may determine a ratio of the number of low values to the number of the plurality of monitoring values as the second ratio of low values.

In this way, the disclosed data communication system 100 can ensure the stability of I2C communication even in environments where data errors may occur due to noise by correcting the bit value stored in the first buffer 220 using the sampling value stored in the second buffer 240.

The processor 250 may perform correction of the bit value stored in the first buffer 220 based on identifying that noise is included in the plurality of monitoring values. When noise is not included in the plurality of monitoring values, correction of the bit value stored in the first buffer 220 may not be performed. In other words, when noise is not included in the plurality of monitoring values, the bit value stored in the first buffer 220 may be output as is.

The operations described as being performed by the master device 200 may also be performed by the slave devices 310, 320, 330.

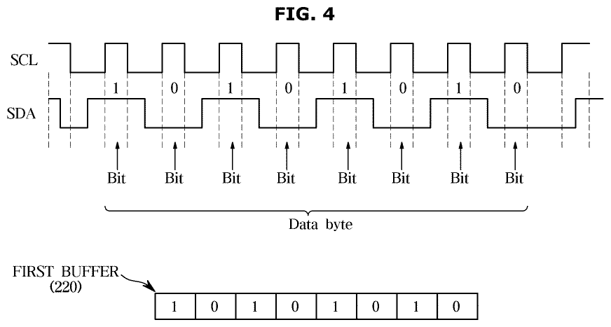

FIG. 4 illustrates a clock signal and a data signal for transmitting data between a master device and a slave device of a data communication system according to an embodiment.

The master device 200 may transmit a clock signal to the slave devices 310, 320, 330 through the clock line SCL. When the master device 200 writes data to the slave devices 310, 320, 330, the data signal of the data line SDA may be transmitted from the master device 200 to the slave devices 310, 320, 330. When the master device 200 reads data from the slave devices 310, 320, 330, the data signal of the data line SDA may be transmitted from the slave devices 310, 320, 330 to the master device 200. Hereinafter, an example of data stored in the first buffer 220 of the master device 200 when the master device 200 reads data from the slave devices 310, 320, 330 is described.

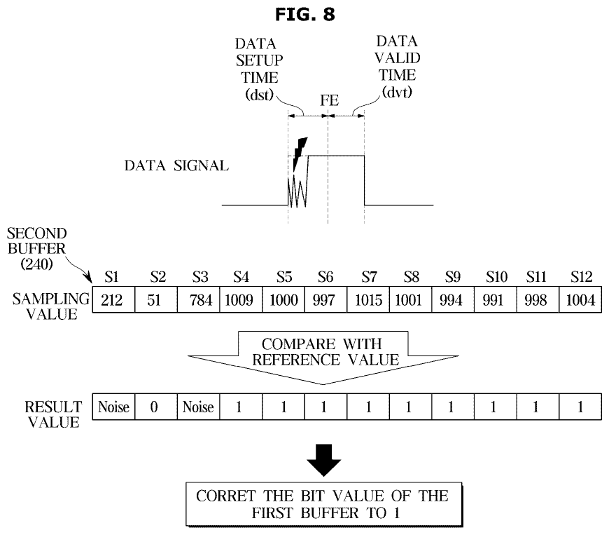

When the data signal of the data line SDA changes from high to low while the clock signal of the clock line SCL is maintained high, data transmission may start. When the clock signal is low, the data signal may change to high or low. When the clock signal is high, the master device 200 determines the data signal as high or low and stores a bit value corresponding to the data signal in the first buffer 220. One bit value may be stored per clock. When the data signal changes from low to high while the clock signal is maintained high, data transmission may end. As illustrated in FIGS. 4, 8 bits, i.e., 1 byte of data may be transmitted. The 8 bit values corresponding to the data signal may be exemplified as 10101010.

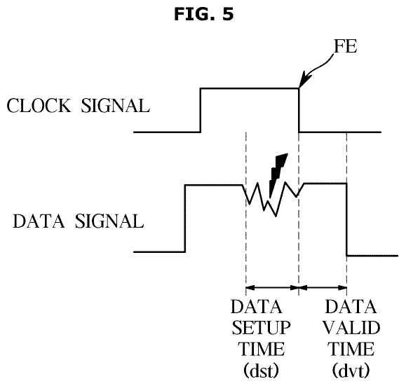

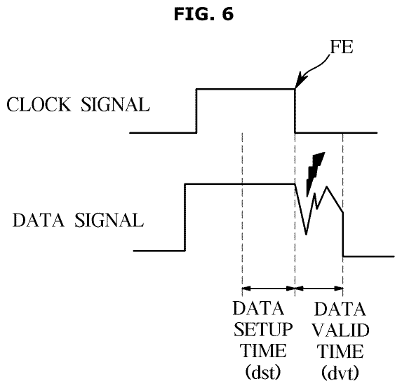

FIGS. 5 and 6 illustrate cases where data errors may occur due to noise.

When the clock signal is high, the data signal must stably maintain high or low to prevent data errors from occurring. To ensure data validity, the data signal must be stably maintained within a predetermined time range based on the falling edge (FE) of the clock. In other words, it is preferable that fluctuation and/or distortion of the data signal does not occur within the data setup time dst before the falling edge (FE) of the clock and the data valid time dvt after the falling edge (FE) of the clock.

However, the data signal transmitted through the data line SDA of I2C communication can be distorted due to the influence of noise. When various electronic components (e.g., AC loads, relays, etc.) included in home appliances operate, noise that affects I2C communication can occur.

FIG. 5 shows a case where the data signal is distorted by noise during the data setup time dst. FIG. 6 shows a case where the data signal is distorted by noise during the data valid time dvt. When the data signal fluctuates due to noise in this way, the bit value may be determined differently from the actual data. In other words, when the data signal is distorted by noise, errors may be included in the data received by the master device 200. For example, in FIGS. 5 and 6, the bit value should be stored as 1, but the bit value may be stored as 0 due to distortion of the data signal.

Therefore, data correction is necessary to ensure data validity in environments where noise that affects I2C communication occurs.

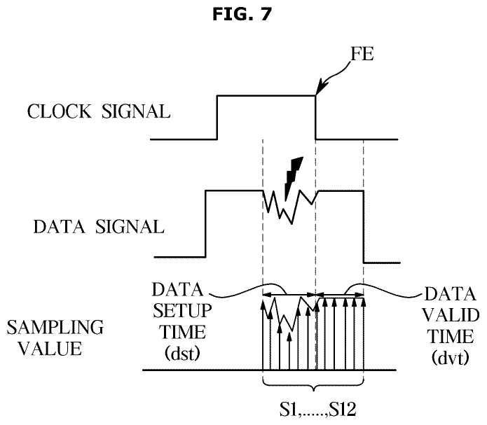

FIG. 7 is a diagram for explaining sampling of a data signal performed by a data communication system according to an embodiment.

Referring to FIG. 7, the master device 200 may acquire a plurality of sampling values by sampling the data signal for each clock of the clock signal. The master device 200 may sample the data signal received through the branch data line ML that branches from the data line SDA. The entire data signal received within one clock period may be sampled. The master device 200 may sample the data signal at predetermined sampling time intervals (e.g., 1 us).

The master device 200 may convert the data signal sampled at each sampling time interval into a digital value of a predetermined number of bits (e.g., 10 bits). The master device 200 may store the converted digital value as a sampling value. A plurality of sampling values may be stored in the second buffer 240 of the master device 200. The sampling value may correspond to a numerical value within a range from 0 to 1024 corresponding to the voltage level of the data signal at each sampling time point.

The master device 200 may determine sampling values acquired within a predetermined time range based on the falling edge FE of the clock among the plurality of sampling values stored in the second buffer 240 as a plurality of monitoring values. For example, the master device 200 may determine sampling values (S1, . . . , S12) acquired within the data setup time dst before the falling edge FE of the clock and the data valid time dvt after the falling edge FE of the clock as the plurality of monitoring values.

The master device 200 may correct the bit value stored in the first buffer 220 using the acquired plurality of monitoring values.

Although sampling of the data signal has been described as being performed by the master device 200, it is not limited thereto. When writing data to the slave devices 310, 320, 330, sampling of the data signal may be performed by the slave devices 310, 320, 330.

FIG. 8 shows an example of data correction performed by a data communication system according to an embodiment.

Referring to FIG. 8, a case is illustrated where a portion of the data signal representing a high value is distorted due to noise during the data setup time dst before the falling edge FE of the clock. As distortion of the data signal occurs in the data setup time dst, a bit that should be stored as a high value in the first buffer 220 may be stored as a low value.

As described above, the plurality of sampling values stored in the second buffer 240 through sampling of the data signal represent digital values of a predetermined number of bits (e.g., 10 bits). The sampling values may correspond to numerical values within a range from 0 to 1024 corresponding to the voltage level of the data signal at each sampling time point.

Additionally, sampling values acquired during the data setup time dst and data valid time dvt may be referred to as a plurality of monitoring values. For example, 12 sampling values (S1, S2, S3, S4, S5, S6, S7, S8, S9, S10, S11, S12) among the plurality of sampling values stored in the second buffer 240 may be determined as monitoring values. The 12 sampling values (S1, S2, S3, S4, S5, S6, S7, S8, S9, S10, S11, S12) extracted as monitoring targets may represent 212, 51, 784, 1009, 1000, 997, 1015, 1001, 994, 991, 998, 1004.

The master device 200 may compare each of the plurality of monitoring values with a reference value to determine each of the plurality of monitoring values as a result value corresponding to a high value, a low value, or noise.

For example, the master device 200 may determine each of the plurality of monitoring values as a high value based on each of the plurality of monitoring values being greater than or equal to a first reference value (e.g., 920). Since the monitoring values from S4 to S12 among the 12 monitoring values are greater than the first reference value, the monitoring values from S4 to S12 may be determined as high values (i.e., 1).

The master device 200 may determine each of the plurality of monitoring values as a low value based on each of the plurality of monitoring values being less than or equal to a second reference value (e.g., 100). The second reference value may be set to be smaller than the first reference value. Since the monitoring value of S2 among the 12 monitoring values is smaller than the second reference value, the monitoring value of S2 may be determined as a low value (i.e., 0).

The master device 200 may determine each of the plurality of monitoring values as noise based on each of the plurality of monitoring values being less than the first reference value and greater than the second reference value. Since the monitoring values of S1 and S3 among the 12 monitoring values are less than the first reference value and greater than the second reference value, the monitoring values of S1 and S3 may be determined as noise.

The master device 200 may determine a first ratio of high values and a second ratio of low values among the plurality of monitoring values. A ratio of the number of high values to the number of the plurality of monitoring values may be determined as the first ratio of high values. A ratio of the number of low values to the number of the plurality of monitoring values may be determined as the second ratio of low values. In FIG. 8, the 12 monitoring values are illustrated as including 9 high values, 1 low value, and 2 noise values. In FIG. 8, the first ratio of high values may be determined as 75 percent, and the second ratio of low values may be determined as 8 percent.

The master device 200 may correct the bit value stored in the first buffer 220 to a high value or a low value based on the first ratio of high values or the second ratio of low values among the plurality of monitoring values being greater than or equal to a threshold value (e.g., 60 percent). In FIG. 8, since the ratio of high values among the 12 monitoring values is 75 percent, which is greater than the threshold value (e.g., 60 percent), the bit value stored in the first buffer 220 may be corrected to a high value (i.e., 1).

In this way, the disclosed data communication system 100 can prevent data errors and ensure the stability of I2C communication even in environments with high noise levels by correcting the bit value stored in the first buffer 220.

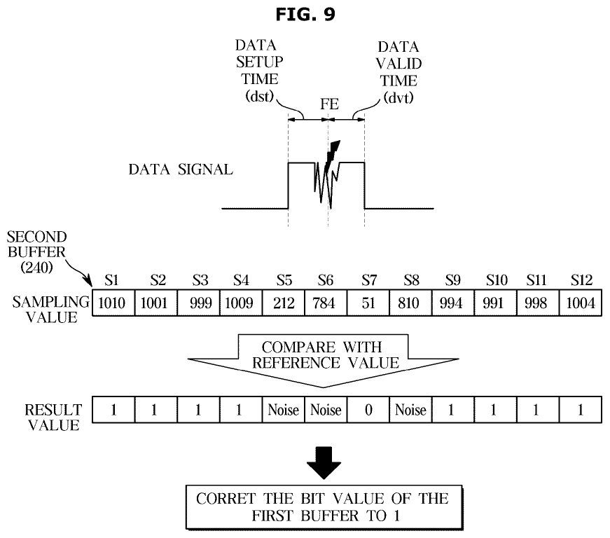

FIG. 9 shows an example of data correction performed by a data communication system according to an embodiment.

Referring to FIG. 9, a case is illustrated where a portion of the data signal representing a high value is distorted due to noise during the data setup time dst before the falling edge FE of the clock and the data valid time dvt after the falling edge FE of the clock. As distortion of the data signal occurs in the data setup time dst and the data valid time dvt, a bit that should be stored as a high value in the first buffer 220 may be stored as a low value.

In FIG. 9, the 12 sampling values S1, S2, S3, S4, S5, S6, S7, S8, S9, S10, S11, S12 extracted as monitoring targets among the plurality of sampling values stored in the second buffer 240 may represent 1010, 1001, 999, 1009, 212, 784, 51, 810, 994, 991, 998, 1004.

Since the monitoring values from S1 to S4 and from S9 to S12 among the 12 monitoring values are greater than the first reference value (e.g., 920), the monitoring values from S1 to S4 and from S9 to S12 may be determined as high values (i.e., 1). Since the monitoring value of S7 is smaller than the second reference value (e.g., 100), the monitoring value of S7 may be determined as a low value (i.e., 0). Additionally, since the monitoring values of S5, S6, and S8 are less than the first reference value and greater than the second reference value, the monitoring values of S5, S6, and S8 may be determined as noise.

In other words, in FIG. 9, the 12 monitoring values are illustrated as including 8 high values, 1 low value, and 3 noise values. In FIG. 9, the first ratio of high values may be determined as 66.7 percent, and the second ratio of low values may be determined as 8 percent. Since the ratio of high values among the 12 monitoring values is 66.7 percent, which is greater than the threshold value (e.g., 60 percent), the bit value stored in the first buffer 220 may be corrected to a high value (i.e., 1).

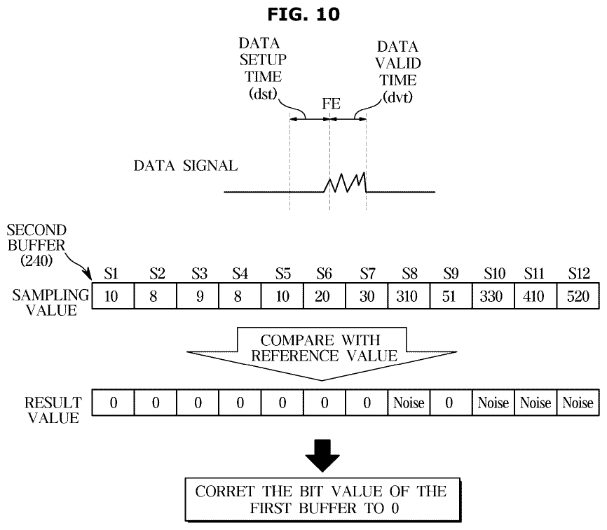

FIG. 10 shows an example of data correction performed by a data communication system according to an embodiment.

Referring to FIG. 10, a case is illustrated where a portion of the data signal representing a low value is distorted due to noise during the data valid time dvt after the falling edge FE of the clock. As distortion of the data signal occurs in the data valid time dvt, a bit that should be stored as a low value may be stored as a high value.

In FIG. 10, the 12 sampling values S1, S2, S3, S4, S5, S6, S7, S8, S9, S10, S11, S12 extracted as monitoring targets among the plurality of sampling values stored in the second buffer 240 may represent 10, 8, 9, 8, 10, 20, 30, 310, 51, 330, 410, 520.

Since the monitoring values from S1 to S7 and S9 among the 12 monitoring values are smaller than the second reference value (e.g., 100), the monitoring values from S1 to S7 and S9 may be determined as low values (i.e., 0). Since the monitoring values of S8 and from S10 to S12 are less than the first reference value and greater than the second reference value, the monitoring values of S8 and from S10 to S12 may be determined as noise.

In other words, in FIG. 10, the 12 monitoring values are illustrated as including 8 low values and 4 noise values. In FIG. 10, the ratio of low values may be determined as 66.7 percent. Since the ratio of low values among the 12 monitoring values is 66.7 percent, which is greater than the threshold value (e.g., 60 percent), the bit value stored in the first buffer 220 may be corrected to a low value (i.e., 0).

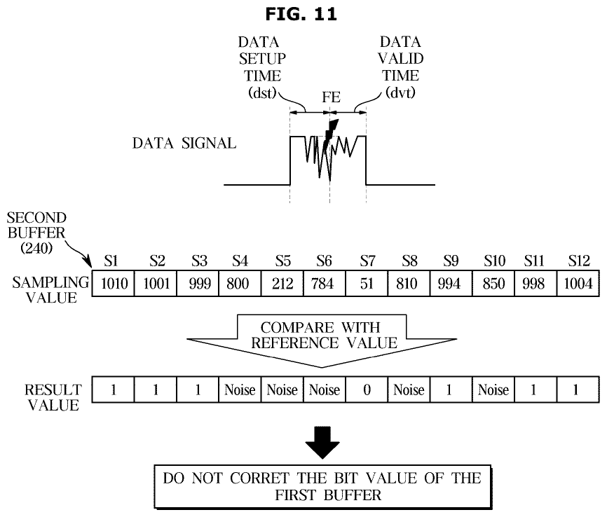

FIG. 11 shows a case where data correction is not performed in a data communication system according to an embodiment.

Referring to FIG. 11, a case is illustrated where most of the data signal representing a high value is distorted due to noise during the data setup time dst before the falling edge FE of the clock and the data valid time dvt after the falling edge FE of the clock. As distortion of the data signal occurs in the data setup time dst and the data valid time dvt, a bit that should be stored as a high value may be stored as a low value.

In FIG. 11, the 12 sampling values S1, S2, S3, S4, S5, S6, S7, S8, S9, S10, S11, S12 extracted as monitoring targets among the plurality of sampling values stored in the second buffer 240 may represent 1010, 1001, 999, 800, 212, 784, 51, 810, 994, 850, 998, 1004.

Since the monitoring values of S1 to S3, S9, S11, and S12 among the 12 monitoring values are greater than the first reference value (e.g., 920), the monitoring values of S1 to S3, S9, S11, and S12 may be determined as high values (i.e., 1). Since the monitoring value of S7 is smaller than the second reference value (e.g., 100), the monitoring value of S7 may be determined as a low value (i.e., 0). Since the monitoring values of S4 to S6, S8, and S10 are less than the first reference value and greater than the second reference value, the monitoring values of S4 to S6, S8, and S10 may be determined as noise.

In other words, in FIG. 11, the 12 monitoring values are illustrated as including 6 high values, 1 low value, and 5 noise values. In FIG. 11, the first ratio of high values may be determined as 50 percent, and the second ratio of low values may be determined as 8 percent. Since both the first ratio of high values and the second ratio of low values among the 12 monitoring values are less than the threshold value (e.g., 60 percent), the bit value stored in the first buffer 220 may not be corrected.

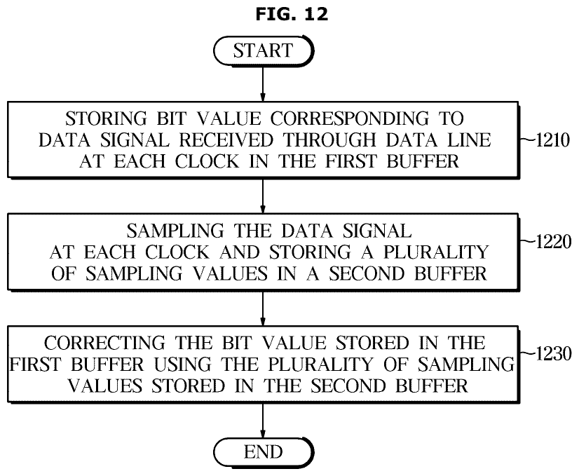

FIG. 12 is a flowchart briefly showing a method for controlling a data communication system according to an embodiment.

As described above, the disclosed data communication system 100 includes a master device 200 and slave devices 310, 320, 330. The master device 200 may perform data communication with the slave devices 310, 320, 330 through a data line SDA and a clock line SCL.

Referring to FIG. 12, the master device 200 of the data communication system 100 may store a bit value corresponding to a data signal received through the data line SDA in the first buffer 220 for each clock of a clock signal transmitted through the clock line SCL (1210). The first buffer 220 may store a plurality of bit values corresponding to data. For example, the data signal may be a voltage signal. For each clock of the clock signal, a bit value of 1 or 0 may be stored in the first buffer 220 depending on whether the voltage level of the data signal is high (e.g., 5V) or low (e.g., 0V). The master device 200 may store a bit value corresponding to the data signal received through the data line SDA for each clock of the clock signal in the first buffer 220.

The master device 200 may sample the data signal for each clock of the clock signal and store a plurality of sampling values in the second buffer 240 (1220). The master device 200 may sample the data signal received through the branch data line ML that branches from the data line SDA. The entire data signal received within one clock period may be sampled. The master device 200 may sample the data signal at predetermined sampling time intervals (e.g., 1 us).

The master device 200 may convert the data signal sampled at each sampling time interval into a digital value of a predetermined number of bits (e.g., 10 bits). The master device 200 may store the converted digital value as a sampling value. A plurality of sampling values may be stored in the second buffer 240 of the master device 200. The sampling value may correspond to a numerical value within a range from 0 to 1024 corresponding to the voltage level of the data signal at each sampling time point.

The master device 200 may perform correction of the bit value stored in the first buffer 220 using the plurality of sampling values stored in the second buffer 240 for each clock of the clock signal (1230).

In this way, the disclosed data communication system 100 can ensure the stability of I2C communication even in environments where data errors may occur due to noise by correcting the bit value stored in the first buffer 220 using the sampling value stored in the second buffer 240.

The operations described as being performed by the master device 200 may also be performed by the slave devices 310, 320, 330.

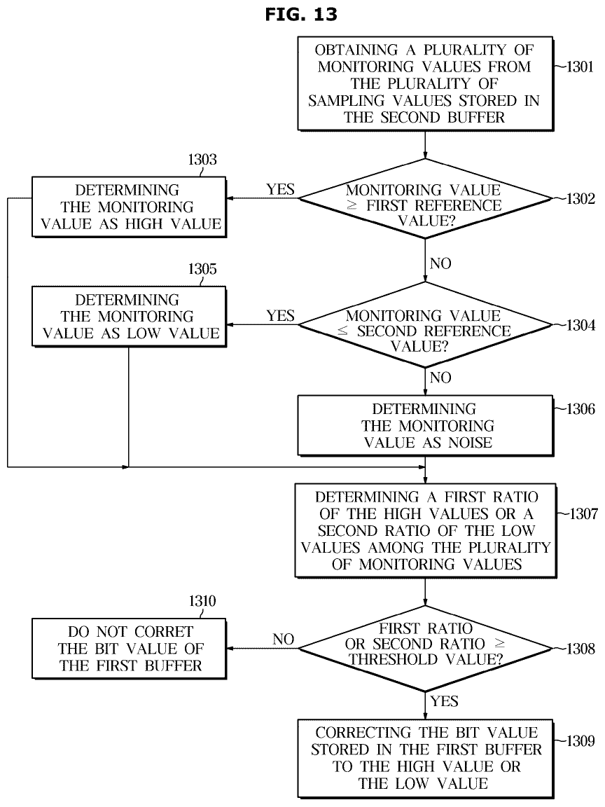

FIG. 13 is a flowchart detailing a method for correcting bit values stored in a first buffer described in FIG. 12.

Referring to FIG. 13, the master device 200 of the data communication system 100 may acquire a plurality of monitoring values from the plurality of sampling values stored in the second buffer 240 (1301). The master device 200 may determine sampling values acquired within a predetermined time range based on the falling edge FE of the clock among the plurality of sampling values stored in the second buffer 240 as a plurality of monitoring values. For example, the master device 200 may determine sampling values acquired within the data setup time dst before the falling edge FE of the clock and the data valid time dvt after the falling edge FE of the clock as the plurality of monitoring values.

The master device 200 may compare each of the plurality of monitoring values with a reference value to determine each of the plurality of monitoring values as a result value corresponding to a high value, a low value, or noise. In other words, the plurality of monitoring values may be identified as high values, low values, or noise.

For example, the master device 200 may determine each of the plurality of monitoring values as a high value based on each of the plurality of monitoring values being greater than or equal to a first reference value (1302, 1303). The master device 200 may determine each of the plurality of monitoring values as a low value based on each of the plurality of monitoring values being less than or equal to a second reference value (1304, 1305). The first reference value may be set to be greater than the second reference value. The master device 200 may determine each of the plurality of monitoring values as noise based on each of the plurality of monitoring values being less than the first reference value and greater than the second reference value (1302, 1304, 1306).

The master device 200 may determine a first ratio of high values and a second ratio of low values among the plurality of monitoring values (1307). For example, the master device 200 may determine a ratio of the number of high values to the number of the plurality of monitoring values as the first ratio of high values. The master device 200 may determine a ratio of the number of low values to the number of the plurality of monitoring values as the second ratio of low values.

The master device 200 may identify whether the first ratio of high values or the second ratio of low values among the plurality of monitoring values is greater than or equal to a threshold value (1308). The master device 200 may correct the bit value stored in the first buffer 220 to a high value or a low value based on the first ratio of high values or the second ratio of low values among the plurality of monitoring values being greater than or equal to the threshold value (1309).

When the first ratio of high values or the second ratio of low values among the plurality of monitoring values is less than the threshold value, the master device 200 may not correct the bit value stored in the first buffer 220 (1310).

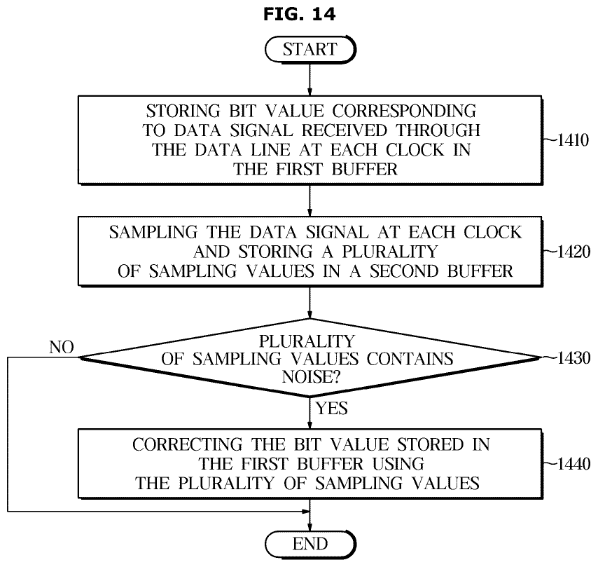

FIG. 14 shows an embodiment that modifies the method for controlling the data communication system described in FIG. 12.

Referring to FIG. 14, the master device 200 of the data communication system 100 may store a bit value corresponding to a data signal received through the data line SDA in the first buffer 220 for each clock of a clock signal transmitted through the clock line SCL (1410). The master device 200 may sample the data signal for each clock of the clock signal and store a plurality of sampling values in the second buffer 240 (1420).

The master device 200 may identify whether noise is included in the plurality of sampling values (1430). The master device 200 may perform correction of the bit value stored in the first buffer 220 based on noise being included in the plurality of sampling values (1440). The master device 200 may determine whether to perform correction of the bit value stored in the first buffer 220 depending on whether noise is included in the monitoring values extracted from the plurality of sampling values.

Operations 1410, 1420, and 1440 correspond to 1210, 1220, and 1230 described in FIG. 12.

When noise is not included in the plurality of sampling values, the master device 200 may not perform correction of the bit value stored in the first buffer 220. In other words, when noise is not included in the plurality of monitoring values, the master device 200 may output the bit value stored in the first buffer 220 as is.

According to an embodiment of the disclosure, a data communication system may include a slave device and a master device configured to perform data communication with the slave device through a clock line that transmits a clock signal and a data line that transmits a data signal. The master device may store a bit value corresponding to the data signal which is received through the data line for each clock of the clock signal in a first buffer. The master device may store a plurality of monitoring values in a second buffer by sampling the received data signal for each clock. The master device may correct the bit value stored in the first buffer using the plurality of monitoring values stored in the second buffer for each clock.

The master device may obtain the plurality of monitoring values within a predetermined time range including a falling edge of the clock.

The master device may determine each of the plurality of monitoring values as a result value corresponding to a high value, a low value, or noise based on comparing each of the plurality of monitoring values with at least one of reference values. The master device may correct the bit value stored in the first buffer using the plurality of result values.

The master device may obtain the plurality of monitoring values within the predetermined time range between a data setup time before the falling edge of the clock and a data valid time after the falling edge of the clock.

The master device may identify a first number of high values and a second number of low values among the plurality of monitoring values for the each clock. The master device may correct the bit value stored in the first buffer to the high value or the low value based on the first number of the high values or the second number of the low values.

The master device may identify a ratio of the first number of high values to a number of the plurality of monitoring values as a first ratio of the high values. The master device may identify a ratio of the second number of low values to the number of the plurality of monitoring values as the second ratio of the low values, and correct the bit value stored in the first buffer to the high value or the low value based on the first ratio or the second ratio being greater than or equal to respective threshold value for each of the first ratio and the second ratio.

The master device may determine each of the plurality of monitoring values as the high value based on each of the plurality of monitoring values being greater than or equal to a first reference value. The master device may determine each of the plurality of monitoring values as the low value based on each of the plurality of monitoring values being less than or equal to a second reference value. The master device may determine each of the plurality of monitoring values as the noise based on each of the plurality of monitoring values being less than the first reference value and greater than the second reference value. The first reference value may be greater than the second reference value.

The master device may determine to correct the bit value stored in the first buffer based on identifying that the noise is included in the plurality of monitoring values.

The master device may convert the data signal sampled at each sampling time interval into a digital value of a predetermined number of bits and store the converted digital value as the plurality of monitoring.

The master device may include a clock port connected to the clock line; a data port connected to the data line and a monitoring port connected to a branch data line branching from the data line.

According to an embodiment of the disclosure, a method for controlling a data communication system, the method may include storing, by a master device configured to perform data communication with a slave device through a data line and a clock line, a bit value corresponding to a data signal received through the data line in a first buffer for each clock of a clock signal transmitted through the clock line; storing, by the master device, a plurality of monitoring values in a second buffer based on sampling the received data signal for each clock; and correcting, by the master device, the bit value stored in the first buffer based on the plurality of monitoring values stored in the second buffer for each clock.

The storing the plurality of monitoring values may include obtaining the plurality of monitoring within a predetermined time range including a falling edge of the each clock.

The correcting the bit value may include determining each of the plurality of monitoring values as a result value corresponding to a high value, a low value, or noise based on comparing each of the plurality of monitoring values with at least one of reference values; and correcting the bit value stored in the first buffer based on a plurality of result values.

The the plurality of monitoring values may be obtained within the predetermined time range between a data setup time before the falling edge of the each clock and a data valid time after the falling edge of the each clock.

The correcting the bit value may include determining a first number of the high values and a second number of the low values among the plurality of monitoring values for the each clock; and correcting the bit value stored in the first buffer to the high value or the low value based on the first number of the high values or the second number of the low values.

The determining the first ratio of the high values and the second ratio of the low values may include identifying a ratio of the first number of high values to the number of a plurality of monitoring values as the first ratio of the high values; and identifying a ratio of the second number of low values to the number of the plurality of monitoring values as the second ratio of the low values; and correcting the bit value stored in the first buffer to the high value or the low value based on the first ratio or the second ratio being greater than or equal to respective threshold value for each of the first ratio and the second ratio.

The comparing each of the plurality of monitoring values with a reference value may include determining each of the plurality of monitoring values as the high value based on each of the plurality of monitoring values being greater than or equal to a first reference value; determining each of the plurality of monitoring values as the low value based on each of the plurality of monitoring values being less than or equal to a second reference value; and determining each of the plurality of monitoring values as the noise based on each of the plurality of monitoring values being less than the first reference value and greater than the second reference value. The first reference value may be greater than the second reference value.

The correcting the bit value may be determined based on identifying that the noise is included in the plurality of monitoring values.

The storing the plurality of monitoring values in the second buffer may include converting the data signal sampled at each sampling time interval into a digital value of a predetermined number of bits; and storing the converted digital value as the plurality of monitoring value.

According to the disclosure, a data communication system and a method for controlling therefore may correct data errors caused by noise in I2C (Inter-Integrated Circuit) communication.

According to the disclosure, a data communication system and a method for controlling therefore may ensure the stability of I2C communication even in environments with high noise levels.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The machine-readable recording medium may be provided in the form of a non-transitory storage medium. Here, when a storage medium is referred to as “non-transitory”, it may be understood that the storage medium is tangible and does not include a signal (e.g., an electromagnetic wave), but rather that data is semi-permanently or temporarily stored in the storage medium. For example, a “non-transitory storage medium” may include a buffer in which data is temporarily stored.

The method according to the various embodiments disclosed herein may be provided in a computer program product. The computer program product may be traded between a seller and a buyer as a product. The computer program product may be distributed in the form of a machine-readable recording medium (e.g., compact disc read only memory (CD-ROM)), or may be distributed (e.g., download or upload) through an application store (e.g., Play StoreTM) online or directly between two user devices (e.g., smartphones). In the case of online distribution, at least a portion of the computer program product (e.g., downloadable app) may be stored at least semi-permanently or may be temporarily generated in a recording medium, such as a memory of a server of a manufacturer, a server of an application store, or a relay server.

Although embodiments of the disclosure have been described with reference to the accompanying drawings, a person having ordinary skilled in the art will appreciate that other specific modifications may be easily made without departing from the technical spirit or essential features of the disclosure. Therefore, the foregoing embodiments should be regarded as illustrative rather than limiting in all aspects.

1. A data communication system comprising:
a slave device; and
a master device configured to perform data communication with the slave device through a clock line that transmits a clock signal and a data line that transmits a data signal;
wherein the master device configured to:
store a bit value corresponding to the data signal which is received through the data line for each clock of the clock signal in a first buffer,
store a plurality of monitoring values in a second buffer based on sampling the received data signal for each clock, and
correct the bit value stored in the first buffer based on the plurality of monitoring values stored in the second buffer for each clock.

2. The data communication system of claim 1, wherein the master device is configured to:
obtain the plurality of monitoring values within a predetermined time range including a falling edge of the each clock.

3. The data communication system of claim 1, wherein the master device is configured to:
determine each of the plurality of monitoring values as a result value corresponding to a high value, a low value, or noise based on comparing the each of the plurality of monitoring values with at least one of reference values, and
wherein the bit value stored in the first buffer is corrected based on a plurality of result values.

4. The data communication system of claim 2, wherein the master device is configured to obtain the plurality of monitoring within the predetermined time range between a data setup time before the falling edge of the each clock and a data valid time after the falling edge of the each clock.

5. The data communication system of claim 3, wherein the master device is configured to:
identify a first number of high values and a second number of low values among the plurality of monitoring values for the each clock, and
correct the bit value stored in the first buffer to the high value or the low value based on the first number of the high values or the second number the low values.

6. The data communication system of claim 5, wherein the master device is configured to:
identify a ratio of the first number of high values to a number of the plurality of monitoring values as a first ratio of the high values,
identify a ratio of the second number of low values to the number of the plurality of monitoring values as the second ratio of the low values, and
correct the bit value stored in the first buffer to the high value or the low value based on the first ratio or the second ratio being greater than or equal to respective threshold value for each of the first ratio and the second ratio.

7. The data communication system of claim 3, wherein the master device is configured to:
determine the each of the plurality of monitoring values as the high value based on the each of the plurality of monitoring values being greater than or equal to a first reference value,
determine the each of the plurality of monitoring values as the low value based on the each of the plurality of monitoring values being less than or equal to a second reference value, and
determine the each of the plurality of monitoring values as the noise based on the each of the plurality of monitoring values being less than the first reference value and greater than the second reference value,
wherein the first reference value is greater than the second reference value.

8. The data communication system of claim 3, wherein the master device is configured to determine to correct the bit value stored in the first buffer based on identifying that the noise is included in the plurality of monitoring values.

9. The data communication system of claim 1, wherein the master device is configured to:
convert the data signal sampled at each sampling time interval into a digital value of a predetermined number of bits, and
store the converted digital value as the plurality of monitoring value.

10. The data communication system of claim 1, wherein the master device comprises:
a clock port connected to the clock line;
a data port connected to the data line; and
a monitoring port connected to a branch data line branching from the data line.

11. A method for controlling a data communication system, the method comprising:
storing, by the a master device configured to perform data communication with a slave device through a data line and a clock line, a bit value corresponding to a data signal received through the data line in a first buffer for each clock of a clock signal transmitted through the clock line;
storing, by the master device, a plurality of monitoring values in a second buffer based on sampling the received data signal for each clock; and
correcting, by the master device, the bit value stored in the first buffer based on the plurality of monitoring values stored in the second buffer for each clock.

12. The method of claim 11, wherein the storing the plurality of monitoring values comprises:
obtaining the plurality of monitoring within a predetermined time range including a falling edge of the each clock.

13. The method of claim 11, wherein the correcting the bit value comprises:
determining each of the plurality of monitoring values as a result value corresponding to a high value, a low value, or noise based on comparing each of the plurality of monitoring values with at least one of reference values; and
correcting the bit value stored in the first buffer based on a plurality of result values.

14. The method of claim 12, wherein the plurality of monitoring values are obtained within the predetermined time range between a data setup time before the falling edge of the each clock and a data valid time after the falling edge of the each clock.

15. The method of claim 13, wherein correcting the bit value comprises:
determining a first number of high values and a second number of low values among the plurality of monitoring values for the each clock; and
correcting the bit value stored in the first buffer to the high value or the low value based on the first number of the high values or the second number of the low values.

16. The method of claim 15, wherein determining the first ratio of the high values and the second ratio of the low values comprises:
identifying a ratio of the first number of high values to a number of the plurality of monitoring values as the first ratio of the high values;
identifying a ratio of the second of low values to the number of the plurality of monitoring values as the second ratio of the low values; and
correcting the bit value stored in the first buffer to the high value or the low value based on the first ratio or the second ratio being greater than or equal to respective threshold value for each of the first ratio and the second ratio.

17. The method of claim 13, wherein comparing each of the plurality of monitoring values with a reference value comprises:
determining the each of the plurality of monitoring values as the high value based on the each of the plurality of monitoring values being greater than or equal to a first reference value;
determining the each of the plurality of monitoring values as the low value based on the each of the plurality of monitoring values being less than or equal to a second reference value; and
determining the each of the plurality of monitoring values as the noise based on the each of the plurality of monitoring values being less than the first reference value and greater than the second reference value,
wherein the first reference value is greater than the second reference value.

18. The method of claim 13, wherein the correcting the bit value stored in the first buffer is determined based on identifying that the noise is included in the plurality of monitoring values.

19. The method of claim 11, wherein the storing the plurality of monitoring values comprises:
converting the data signal sampled at each sampling time interval into a digital value of a predetermined number of bits, and
storing the converted digital value as the plurality of monitoring value.

20. The method of claim 11, wherein the master device comprises:
a clock port connected to the clock line;
a data port connected to the data line; and
a monitoring port connected to a branch data line branching from the data line.
